(19) United States
(12) Patent Application Publication
(10) Pub. No.: US 2025/0023126 A1
(43) Pub. Date: Jan. 16, 2025

(54) Temperature Testing Apparatuses and Systems for Testing Battery Cells and Related Methods

(71) Applicant: SES (Shanghai) Co., Ltd., Shanghai (CN)

(72) Inventors: Yong Duan, Shanghai (CN); Luyong Shen, Shanghai (CN); Biao Xu, Shanghai (CN)

(21) Appl. No.: 18/770,786

(22) Filed: Jul. 12, 2024

Related U.S. Application Data
(60) Provisional application No. 63/526,716, filed on Jul. 14, 2023.

(51) Int. Cl. H01M 10/42; G01K 7/22

(52) U.S. Cl. CPC H01M 10/4285; G01K 7/22; G01K 2219/00

(57) ABSTRACT

In some embodiments, temperature-testing apparatuses that each include a pair of spaced-apart pressure plates, a testing plate, and a pressure fixture. The testing plate may comprise a working face with a plurality of recesses that confronts a face of the battery cell being tested, a temperature sensor in each one of the plurality of recesses, and electronic circuitry in operative communication with each of the temperature sensors. In some embodiments, the pressure fixture is a constant-pressure mechanism. In some embodiments, the pressure fixture is a constant-gap pressure mechanism. Systems containing such temperature-testing apparatuses and methods of testing with such temperature-testing apparatuses are also disclosed.

### CROSS-REFERENCE TO RELATED APPLICATIONS

This application claims the benefit of priority of U.S. Provisional Patent Application Ser. No. 63/526,716, filed Jul. 14, 2023, and titled “Temperature Testing Apparatuses and Systems for Testing Battery Cells and Related Methods”, which is incorporated herein by reference in its entirety for all purposes.

### FIELD

The present disclosure generally relates to the field of temperature testing of battery cells. In particular, the present disclosure is directed to temperature testing apparatuses and systems for testing battery cells and related methods.

### BACKGROUND

Generally, there are two conventional methods for measuring the temperature of a single battery cell. One is to use a thermal imager to detect the surface temperature of the cell by detecting infrared radiation emitted from the cell, which is displayed in one or more colors on a thermal imaging display, with differing colors representing differing temperatures. The other conventional method is to paste a thermocouple onto the cell using a thermal silica gel and then collect and display temperature data acquired via the thermocouple using a data-acquisition instrument and display, respectively.

With a thermal imager, temperature cannot be measured when something blocks the thermal imager from directly viewing the part(s) of a cell for which temperature data is desired. In cell testing involving holding pressure within the battery cell using a pressure fixture, opposing faces of the battery cell are fixed in and pressed by the pressure fixture in a direction along the internal stacking axis of the cell. Therefore, parts of the pressure fixture prevent the thermal imager from detecting infrared radiation across an entire face of the cell, which is where temperature data is most critical.

Regarding thermocouples in the context of cell testing that uses a pressure fixture, only the temperature of an outer edge of a battery cell can be detected. This is so because if a thermocouple were pasted onto a face of the cell that is engaged by the pressure fixture, then the thermocouple would pierce that face and damage the cell. Therefore, thermocouples cannot detect temperatures on the face of a battery cell clamped within a pressure fixture.

### BRIEF DESCRIPTION OF THE DRAWINGS

For the purpose of illustration, the accompanying drawings show aspects of one or more embodiments of the disclosure. However, it should be understood that the scope of this disclosure is not limited to the precise arrangements and instrumentalities shown in the drawings, wherein:

FIG. 1 is an exploded view of an example temperature-testing apparatus made in accordance with aspects of the present disclosure;

FIG. 2 is an exploded view of another example temperature-testing apparatus made in accordance with aspects of the present disclosure;

FIG. 3A is a cross-sectional view of an example testing plate of the present disclosure engaged with a battery cell;

FIG. 3B is an exploded cross-sectional view of the example testing plate of FIG. 3A; and

FIG. 4 is a diagram illustrating an example temperature-testing system and testing ecosystem made in accordance with the present disclosure and including the example temperature-testing apparatus of either of FIGS. 1 and 2.

### SUMMARY OF THE DISCLOSURE

In one implementation, the present disclosure is directed to a testing plate for testing a device-under-test (DUT), having spaced-apart faces, in a pressure fixture that applies to and/or resists pressure from the DUT during testing, the pressure fixtures including a pair of spaced-apart pressure plates. The testing plate includes a body designed and configured to be located between the DUT and one of the pressure plates when the DUT is pressurized within the pressure fixture, the body including: a working face that confronts one of the spaced-apart faces of the battery cell during testing; a plurality of recesses formed in the working face and distributed across the working face; and a temperature sensor located in each one of the plurality of recesses; and electronic circuitry in operative communication with each of the temperature sensors.

In another implementation, the present disclosure is directed to an apparatus for testing a device-under-test (DUT) having spaced-apart faces. The apparatus includes a pressure fixture that includes a pair of pressure plates and a pressurizing mechanism that causes the pressure plates to induce pressure within the DUT when the DUT is present between the pressure plates for testing, the spaced-apart faces facing corresponding ones of the pressure plates during the testing; a testing plate as described herein.

### DETAILED DESCRIPTION

The entire contents of the appended claims are incorporated into this Detailed Description section as if originally presented herein.

In some aspects, the present disclosure is directed to a temperature-testing plate (simply “testing plate” hereinafter) for acquiring temperatures across a surface of a device-under-test (DUT), such as a battery cell (simply “cell” hereinafter). As discussed in the background section above, single-cell testing can involve monitoring the temperature of a cell during testing, for example, charge-discharge cycle testing. However, in some testing scenarios, such as testing while the cell is clamped in a pressure fixture, it is not possible to use a thermal imager or thermocouples pasted to a cell in a conventional manner. A testing plate of the present disclosure provides a way to measure temperature across as much of a face of a battery cell as needed or desired to suit testing and temperature-data acquisition.

In some embodiments, a testing plate of this disclosure includes a body having a working face that will confront a face of a DUT when the testing plate is engaged with the DUT for testing. The working face includes a plurality of recesses that each contain a temperature sensor, such as a negative-temperature-coefficient (NTC) thermistor, among others. The recesses and corresponding temperature sensors may be arranged in any suitable pattern, such as, for example, a regular rectangular array, a circular array, or a non-standard arrangement, such as an arrangement that conforms to an irregularly shaped face of the DUT. The spacing between immediately adjacent pairs of the recesses/temperature sensors may be any spacing desired for a particular type of test. For example, in the context of a rectangular array, the spacings may be the same along both of the orthogonal axes of the array, may be different as between the two orthogonal axes, or may vary along one or both of the orthogonal axes, or any logical combination thereof. Examples of circular arrays include circular arrays based on concentric rings of recesses/temperature sensors and circular arrays based on orthogonal axes, among others. Fundamentally, there are no limitations on how the recesses and temperature sensors are arranged as long as they provide the desired/necessary results.

Each temperature sensor is electrically connected to suitable circuitry that makes the sensor operational. In some embodiments, a portion of such circuitry is contained in a flexible printed circuit (FPC) located opposite the working face of the testing plate. In some of such embodiments, the testing plate may include a rigid faceplate secured to the FPC. The rigid faceplate may contain recesses or through-holes, depending on the construction, that contain the temperature sensors and are located in a one-to-one registration with electrical sensor contacts on the FPC that electrically interface with the temperature sensors located in the recesses or through-holes of the rigid faceplate. In one example, the rigid faceplate is composed of a printed circuit board (PCB) having a thickness able to accommodate the selected temperature sensors so that the sensors are either recessed or flush relative to the working face of the testing plate. In some embodiments, it is desirable that the rigid faceplate be flame resistant and/or have a high dielectric constant so as to act as an electrical insulator. Examples of other suitable materials include, but are not limited to certain polymers and composites, among others. In some embodiments, the sensors are recessed by, for example, 0.5 mm or more or less. Depending on the type(s) of sensors used, the PCB may include electrical contacts for interfacing with the electrical contact of the FPC. If through-holes are provided on the rigid faceplate, then the temperature sensor may be in direct electrical contact with the electrical contacts on the FPC.

The table below presents some example sizes of semiconductor-based NTC sensors. The numbers in the first column are four-digit codes of the Electronic Industries Association of America (EIA) based on the plan areal size of the sensor in inches. The numbers in the second column are EIA four-digit codes based on sensor size in millimeters. For example, the “0402” code in column 1 designates a sensor that is nominally 0.04 inch×0.02 inch, and the corresponding “1005” code in the second column indicates that the same sensor is 1.0 mm×0.5 mm. Any of these sensor sizes, among others, can be used.

| EIA Code | EIA Code | | | | | |
|---|---|---|---|---|---|---|
| Based on | Based on | | | | | |
| Sensor | Sensor | | | | | |
| Size | Size | Length | Width | Thickness | a | b |
| (inches) | (mm) | (mm) | (mm) | (mm) | (mm) | (mm) |
| 0201 | 0603 | 0.60 ± 0.05 | 0.30 ± 0.05 | 0.23 ± 0.05 | 0.10 ± 0.05 | 0.15 ± 0.05 |
| 0402 | 1005 | 1.00 ± 0.10 | 0.50 ± 0.10 | 0.30 ± 0.10 | 0.20 ± 0.10 | 0.25 ± 0.10 |
| 0603 | 1608 | 1.60 ± 0.15 | 0.80 ± 0.15 | 0.40 ± 0.10 | 0.30 ± 0.20 | 0.30 ± 0.20 |
| 0805 | 2012 | 2.00 ± 0.20 | 1.25 ± 0.15 | 0.50 ± 0.10 | 0.40 ± 0.20 | 0.40 ± 0.20 |
| 1206 | 3216 | 3.20 ± 0.20 | 1.60 ± 0.15 | 0.55 ± 0.10 | 0.50 ± 0.20 | 0.50 ± 0.20 |
| 1210 | 3225 | 3.20 ± 0.20 | 2.50 ± 0.20 | 0.55 ± 0.10 | 0.50 ± 0.20 | 0.50 ± 0.20 |
| 1812 | 4832 | 4.50 ± 0.20 | 3.20 ± 0.20 | 0.55 ± 0.10 | 0.50 ± 0.20 | 0.50 ± 0.20 |
| 2010 | 5025 | 5.00 ± 0.20 | 2.50 ± 0.20 | 0.55 ± 0.10 | 0.60 ± 0.20 | 0.60 ± 0.20 |
| 2512 | 6432 | 6.40 ± 0.20 | 3.20 ± 0.20 | 0.55 ± 0.10 | 0.60 ± 0.20 | 0.60 ± 0.20 |

The FPC may include an external-contact region and a lead-out region containing, respectively, external electrical contacts for interfacing with additional circuitry (e.g., analog-to-digital converters, signal conditioning circuitry, microprocessor(s), memory, etc.) and electrical lead-out conductors for electrically connecting the electrical sensor contacts and the external electrical contacts with one another. The rigid faceplate and the FPC may be fastened together using any suitable means, such as adhesive bonding, mechanical connectors (e.g., threaded fasteners, interference fit parts, clamps, friction fit, etc.), and welding, among others, and any suitable combination thereof. The construction and fabrication of FPCs is well known in the art.

The temperature sensors may be positioned in the recesses in any suitable manner. Because a goal of the testing plate is to provide contact with a face of the DUT that is as uniform as practicable, it is often desirable that the temperature sensors be flush or nearly flush with the working face of the testing plate as practicable. In some embodiments, the testing plate is used with a thermally conductive gel deployed between the working face of the testing plate and the tested face of the DUT. Generally, such a gel is incompressible, such that even if the temperature sensors are somewhat recessed relative to the working fact of the testing plate, the thermally conductive gel can be provided to fill the voids so as to provide a uniform pressure across the working face of the testing plate during testing under the influence of pressure. In this case, the rigid faceplate and the FPC are designed to withstand at least the maximum pressure that might occur during testing, and the thermal sensors are firmly mounted within the recesses so that they too can withstand a share of the pressure loads.

In some embodiments, a testing plate of the present disclosure may have a pair of working faces, and corresponding pluralities of recesses and temperature sensors, located on opposite sides of the testing plate. For convenience, such embodiments may be referred to as “double-sided” testing plates. In an example, a double-sided testing plate may be located between a pair of DUTs, such as a pair of battery pouch cells. This way, temperature data can be acquired for both of the DUTs in the pair. As an example, a double-sided testing plate may comprise two rigid plates, each the same as or similar to the rigid plates discussed above, that sandwich an FPC that provides electrical connections to the temperature sensors on both sides of the double-sided testing plate.

In some aspects, the present disclosure is directed to a temperature-testing apparatus for testing cells, such as a pouch-type cell incorporating a lithium (Li)-based electrochemistry, such as an Li-metal (plating-type Li-metal anode) electrochemistry or a Li-ion (intercalating-type Li anode) electrochemistry having any one or more suitable types of electrolyte, such as a liquid electrolyte, a gel electrolyte, or a solid electrolyte. Electrochemistries based on cations other than Li cations, such as sodium cations, potassium cations, and sulfur cations, among others, are included within the scope of the present disclosure, since the type of DUT is not a limiting factor.

In some embodiments, the temperature-testing apparatus includes a pressure fixture that maintains the cell(s) under pressure in the stacking direction of the battery cell during testing, for example, charge-discharge cycle testing. Here, the stacking direction is the direction along which internal components, such as anode(s), cathode(s), separator(s), etc. are stacked with one another to form the cell. When provided, the pressure fixture may include a pair of pressure plates that, during testing, apply pressure to and/or resist pressure from the one or more cells captured between the pressure plates. Also captured between the pressure plates during testing are one or more testing plates made in accordance with the present disclosure, such as any one of the testing plates discussed above. If more than one cell is being tested, each pair of adjacent cells may be separated by one testing plate (e.g., a double-sided testing plate) or two testing plates (e.g., single-sided testing plates with the working faces thereof confronting corresponding respective ones of the two immediately adjacent cells. The pressure plates are designed and configured to be at least rigid enough that they provide a highly uniform pressure across the faces of the pressure plates.

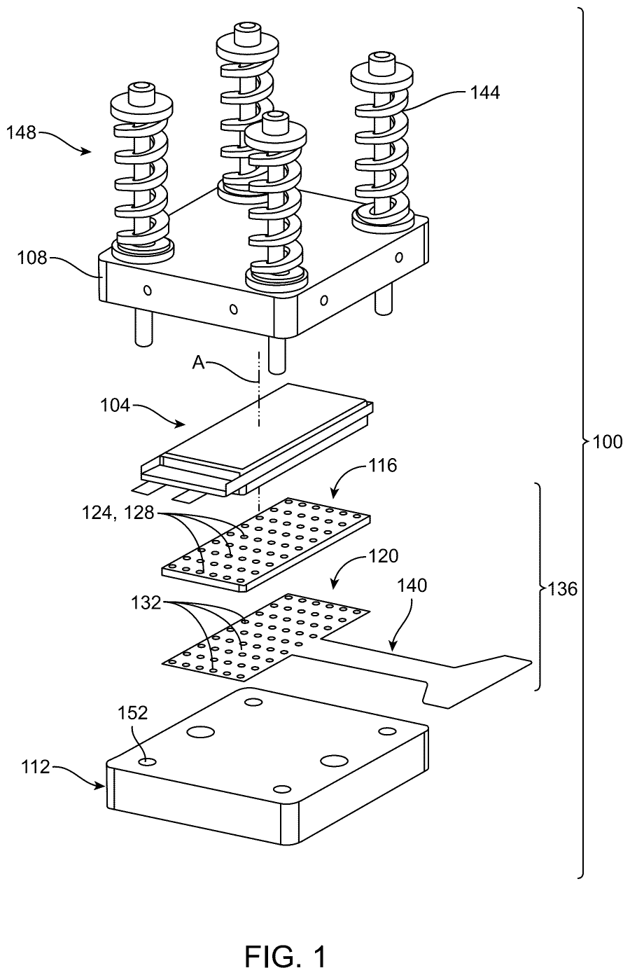

The pressure fixture, if provided, further includes a pressure mechanism that can be controlled and/or set to provide a desired pressure or pressure profile during testing. Pressure mechanisms for cell-testing pressure fixtures are known. However, example pressure mechanisms include spring-type mechanisms (sec, e.g., FIG. 1), hydraulic-type mechanisms, and screw-type mechanisms, among others. Fundamentally, the type of pressure mechanism provided can be any suitable type for the testing performed with the temperature-testing apparatus.

### EXAMPLE EMBODIMENTS

FIG. 1 illustrates an example testing system that includes a temperature-testing apparatus 100 of the present disclosure and a single cell 104, showing the general arrangement of primary elements of the temperature-testing apparatus for acquiring temperature data across one of the faces of the cell during testing, such as charge-discharge cycle testing. In this embodiment, the primary elements include a pair of pressure plates 108, 112, a rigid faceplate 116, and an FPC 120. Those skilled in the art will readily appreciate that FIG. 1 shows the elements of the temperature-testing apparatus 100 exploded along cell stacking axis A but that, during testing, all of the gaps shown between the pressure plates 108, 112, battery cell 104, rigid faceplate 116, and FPC 120 will be eliminated so that immediately adjacent ones of these elements will be in firm contact with one another. The rigid faceplate 116 may contain through-holes 124 that contain temperature sensors 128 and are located in a one-to-one registration with electrical sensor contacts 132 on the FPC 120 that electrically interface with the temperature sensors located in the through-holes of the rigid faceplate (only a few of each of the through-holes, temperature sensors, and electrical sensor contacts labeled to avoid clutter). Together, the rigid faceplate 116 with the through-holes 124, the FPC 120 with the electrical sensor contacts 132, and the temperature sensors 128 form a testing plate 136. Regarding the rigid faceplate 116 and the FPC 120 of the testing plate 136 in particular, as discussed above, these may be secured together so that the testing plate is a unitary element. The FPC 120 includes a lead-out region 140 containing electrical lead-out conductors (not shown) for electrically connecting the electrical sensor contacts 132 and external electrical contacts (not shown) with one another.

In this example, pressure is induced in the elements between the pressure plates 108, 112 via four threaded spring screws 144 (threads not shown) that are part of a constant-pressure mechanism 148. Pressure is induced into the cell 104 by engaging the threaded spring screws 144 into four corresponding threaded openings 152 in the lower (relative to FIG. 1) pressure plate 112 and tightening the spring screws to the extent needed/desired to induce the appropriate pressure into the stack of elements between the pressure plates 108, 112. As those skilled in the art will readily appreciate, the magnitude of the pressure induced into the cell 104 is controlled by amounts that the springs (not separately labeled) are compressed by the screws, and the induced pressure remains largely constant even when the cell changes thickness as the anodes (not shown) within the cell plate and strip during, respectively, charging and discharging, such as occurs in a metal-anode cell, for example, a lithium-metal cell. Other aspects of the temperature-testing apparatus 100 of FIG. 1 not particularly described may be the same as or similar to such aspects as described above and/or as captured in the appended claims.

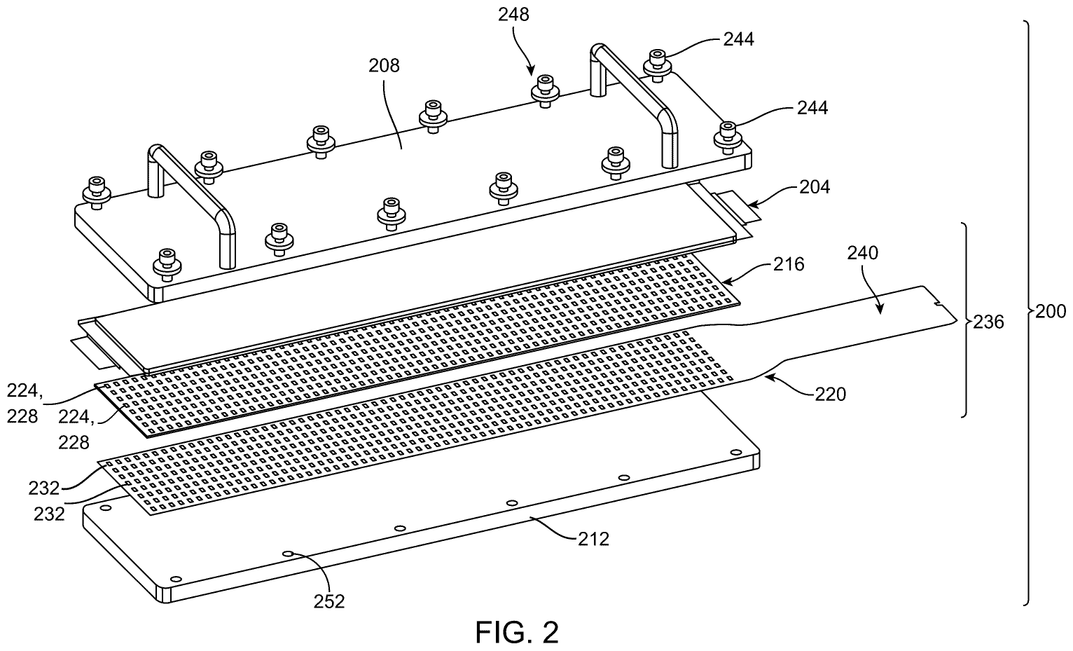

FIG. 2 illustrates another example testing system that includes a temperature-testing apparatus 200 of the present disclosure and a single battery cell 204, showing the general arrangement of the primary elements of the temperature-testing apparatus for acquiring temperature data across one of the faces of the cell during testing, such as charge-discharge cycle testing. Like components of FIGS. 1 and 2 are denoted by the same last two digits. Primary differences between the temperature-testing apparatuses of FIGS. 1 and 2 are that the temperature-testing apparatus 200 of FIG. 2 does not include the constant-pressure mechanism 148 present in FIG. 1, that the cell 204 of FIG. 2 is larger than the cell 104 of FIG. 1, and that the FPC 220 of FIG. 2 has a lead-out portion 240 that is both configured and located differently relative to the lead-out portion 140 of FIG. 1.

In this embodiment, the primary elements include a pair of pressure plates 208, 212, a rigid faceplate 216, and an FPC 220. Those skilled in the art will readily appreciate that FIG. 2 shows the elements of the temperature-testing apparatus 200 in an exploded format but that, during testing, all of the gaps between the pressure plates 208, 212, battery cell 204, rigid faceplate 216, and FPC 220 will be eliminated so that immediately adjacent ones of these elements will be in firm contact with one another. The rigid faceplate 216 may contain through-holes 224 that contain temperature sensors 228 and are located in a one-to-one registration with electrical sensor contacts 232 on the FPC 220 that electrically interface with the temperature sensors located in the through-holes of the rigid faceplate (only two of each of the through-holes, temperature sensors, and electrical sensor contacts labeled to avoid clutter). Together, the rigid faceplate 216 with the through-holes 224, the FPC 220 with the electrical sensor contacts 232, and the temperature sensors 228 form a testing plate 236. Regarding the rigid faceplate 216 and FPC 220 of the testing plate 236 in particular, as discussed above, these may be secured together so that the testing plate is a unitary element. The lead-out portion 240 of the FPC 220 contains electrical lead-out conductors (not shown) for electrically connecting the electrical sensor contacts 232 and external electrical contacts (not shown) with one another.

In this example, pressure is induced in the elements between the pressure plates 208, 212 by engaging the twelve threaded screws 244 of the constant-gap pressure mechanism 248 into twelve corresponding threaded openings 252 in the lower (relative to FIG. 2) pressure plate 212 and tightening the screws to the extent needed/desired to induce the appropriate pressure into the stack of elements between the pressure plates. As those skilled in the art will readily appreciate, the magnitude of the pressure induced into the cell 204 is controlled by adjusting the threaded screws 244 so that a desired gap exists between the testing plate 236 and the pressure plate 208 on the opposite side of the cell. Because the gap remains constant, the induced pressure changes as the cell 204 changes thickness when the anodes (not shown) within the cell plate and strip during, respectively, charging and discharging, such as occurs in a metal-anode cell, for example, a lithium-metal cell. Other aspects of the temperature-testing apparatus 200 of FIG. 2 not particularly described may be the same as or similar to such aspects as described above and/or as captured in the appended claims.

In an example instantiation of a testing plate 236 made in accordance with the present disclosure, the rigid faceplate 216 comprises a PCB and the temperature sensors 228 comprise NTC thermistors. The PCB includes an 8×64 array of through-holes 224 and NTC thermistors contained therein, for a total of 512 NTC thermistors. The thickness of the PCB is only slightly larger than the thickness of each NTC thermistor, and the size of each through-hole 224 is slightly larger than the size of each NTC thermistor. This construction enables the NTC thermistors to detect the surface temperature of the cell 204 without directly touching the surface of the cell. A thermally conductive gel may be used as the testing situation warrants.

An FPC 220 provides a backplane that is mounted to the PCB. The FPC includes an 8×64 array of electrical contacts 232 to match the 8×64 array of NTC thermistors. In this instantiation, the FPC 220 also includes an A/D sampling integrated-circuit (IC) chip (not shown) for every 16 NTC thermistors, for a total of 32 IC chips for the entire 512 NTC thermistors. Including the IC chips directly on the FPC reduces interference and noise in the electronic circuitry that collects the temperature data from the NTC thermistors.

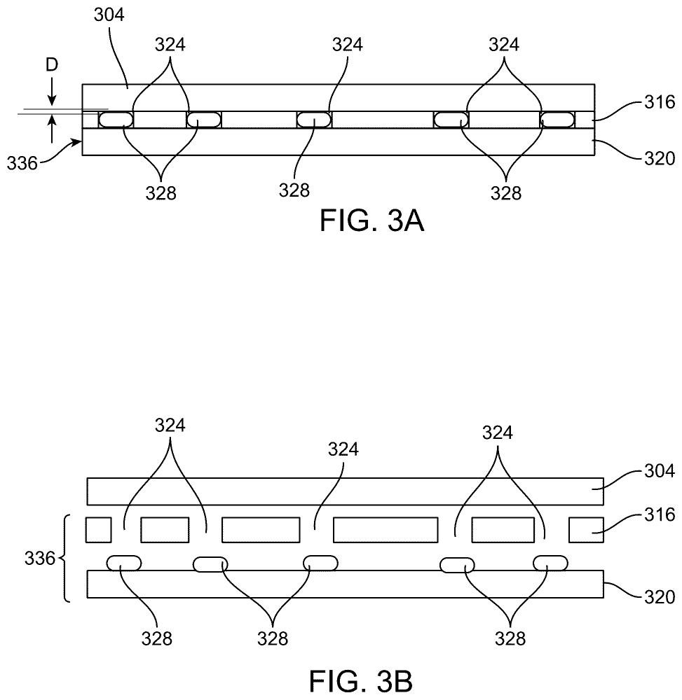

FIGS. 3A and 3B illustrate an example testing plate 336 of the present disclosure, which could be used for either of the testing plates 136, 236 of FIGS. 1 and 2. Like components of FIGS. 1, 2, 3A, and 3B are denoted by the same last two digits. As seen in FIGS. 3A and 3B, this embodiment has sensors 328 located in through holes 324 in the rigid faceplate 316 (e.g., a PCB, among other possibilities) so that the uppermost (relative to FIG. 3A) surfaces of the sensors are recessed by a distance D that is about 0.5 mm from the upper (relative to FIG. 3A) surface of the rigid faceplate that confronts the cell 304. The FPC 320 and the sensors 328 may be any suitable FPC and sensors, such as an FPC and sensors described herein. As shown in FIG. 3B, the sensors 328 may be attached to the FPC 320, such as by soldering them to electrical contacts (not shown). Other aspects of the example testing plate 336 of FIGS. 3A and 3B may be the same as or similar to such aspects noted elsewhere in this disclosure.

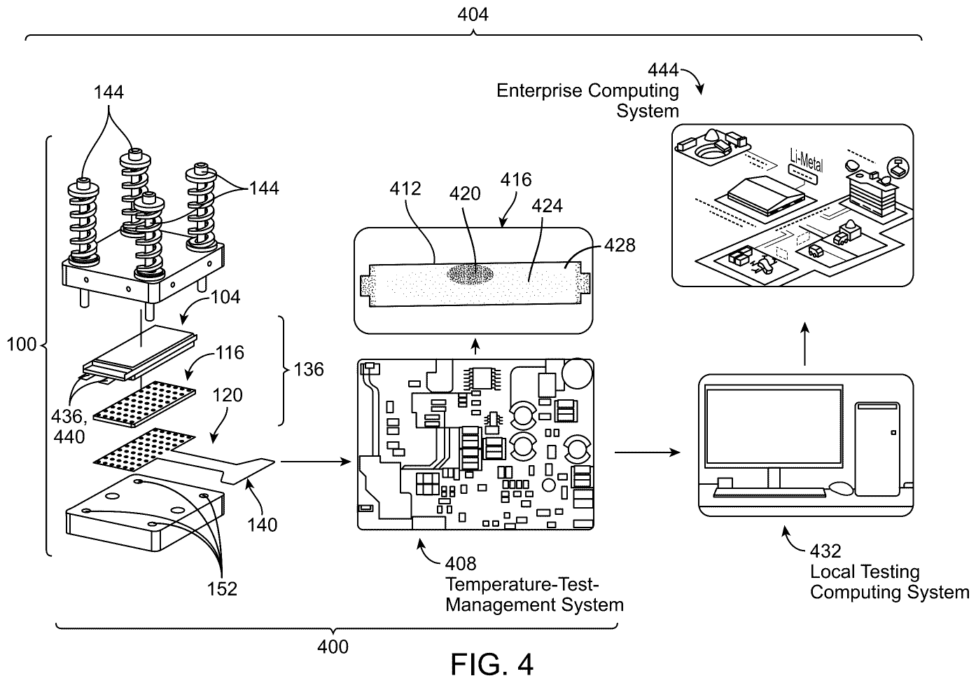

FIG. 4 illustrates an example temperature-testing system 400 and an example overall testing ecosystem 404 that includes a temperature-testing apparatus of the present disclosure, such as either of the temperature-testing apparatuses 100, 200 discussed above and shown in FIGS. 1 and 2. In the example temperature-testing system 400 of FIG. 4, the external electrical contacts (not illustrated) of the external-contact region 140 of the FPC 120 of the testing plate 136 (here, the combination of the FPC 120+rigid faceplate 116, as discussed above) are electrically connected to a temperature-test-management system 408, which in this example includes circuitry for operating the temperature sensors aboard the testing plate 136 and collecting temperature data from the temperature sensors.

Once the temperature data is collected, a temperature-distribution image 412 may be displayed on a suitable display 416 using suitable imaging software. In some embodiments, the imaging software may be configured to provide plots of differing colors, which may be similar to the multi-color images that infrared thermal imagers output. For example, red may indicate the hottest region(s), blue may indicate the coldest region(s), yellow may indicate a region with a middling temperature, and blends of adjacent ones of these colors (blue+yellow and yellow+red) may represent regions having temperatures in between the temperatures of the two colors. In the example temperature-distribution image 412 of FIG. 4, a red hot spot 420 is surrounded by a yellow middle region 424, and the yellow middle region is surrounded by a blue cooler region 428. While the temperature sensors are located at discrete locations within their arrangement on the testing plate 136, the imaging software may include algorithms for interpolating temperature values between any two actual readings so as to create a visually continuous image that includes color blends or other gradations representing the interpolated temperatures between the actual measurement locations.

The example testing ecosystem 404 may optionally include a local testing computing system 432 that includes hardware and software for controlling the overall testing of the cell 104, including the temperature testing via the temperature-testing system 400 and testing of the cell that can cause the temperature changes being monitored by the temperature-testing system, such as life-cycle testing and/or testing involving severe operating conditions, among others. It is noted that electrical connections between the local testing computing system 432 and the cell 104, e.g., via the cell's tabs 436, 440, are not shown in FIG. 4 but may be the same or similar to such connections well-known in the field of cell testing. Also not shown are other components that may be used during testing, such as, but not limited to, a testing chamber, pressure sensors, environmental controls (heaters, coolers, fans, etc.), and corresponding systems, among other things. Each of these components, as needed or provided, may be the same as or similar to such components well-known in the field of cell testing.

In the example of FIG. 4, the testing ecosystem 404 may also include an enterprise computing system 444 that collects and stores testing data and that may include algorithms for using the testing data as needed, such as to design battery management systems, among other things. Other aspects of the temperature-testing system 400 and testing ecosystem 404 of FIG. 4 not particularly described may be the same as or similar to such aspects as described above and/or as captured in the appended claims.

In some aspects, the present disclosure is directed to a temperature tester for testing a device-under-test (DUT), having spaced-apart faces, in a pressure fixture that includes a pair of pressure plates and a pressurizing mechanism that causes the pressure plates to induce pressure within the DUT when the DUT is present between the pressure plates for testing. The temperature tester includes a testing plate in accordance with any of the claims in this application; electronic circuitry in operative communication with each of the temperature sensors.

In one or more embodiments of the temperature testing, the DUT comprises a battery cell.

In one or more embodiments of the temperature testing, during testing, a thermal gel is located between each temperature sensor and the spaced-apart face of the DUT proximate to the testing plate.

In one or more embodiments of the temperature testing, the temperature sensors are functionally grouped into a plurality of groups, and the electronic circuitry includes circuitry for processing temperature-sensor signals from the temperature sensors on a group-by-group basis.

In some aspects, the present disclosure is directed to a method of testing a battery cell having spaced-apart faces. The method includes placing the battery cell in a pressuring test fixture between a pair of pressure plates so that one of the spaced-apart faces confronts a working face of a pressure plate located between the pressure plates and so as to form a testing stack having a stacking direction, wherein the testing plate includes a plurality of recesses each containing a temperature sensor; causing the pressure plates to induce pressure into the testing stack in a direction parallel to the stacking direction; electrically cycling the battery cell; and collecting temperature data for the battery cell via the temperature sensors.

In one or more embodiments of the method, each of the temperature sensors is a negative temperature coefficient-type temperature sensor.

In one or more embodiments of the method, each temperature sensor has a front face confronting the battery cell during testing, wherein the front face is recessed within recess containing the temperature sensor.

In one or more embodiments of the method, during testing, a thermal gel is located between each temperature sensor and the spaced-apart face of the battery cell proximate to the testing plate.

In one or more embodiments of the method, the plurality of recesses are arranged in an array on the working face of the testing plate.

In one or more embodiments of the method, the testing plate includes 30 or more of the recesses.

In one or more embodiments of the method, the temperature sensors are functionally grouped into a plurality of groups, and the electronic circuitry includes circuitry for processing temperature-sensor signals from the temperature sensors on a group-by-group basis.

In one or more embodiments of the method, the testing plate comprises a rigid faceplate containing a plurality of through-holes that provide the plurality of recesses.

In one or more embodiments of the method, the testing plate further comprises a backplane to which the temperature sensors are secured.

In one or more embodiments of the method, wherein the backplane comprises a flexible printed circuit.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A testing plate for testing a device-under-test (DUT), having spaced-apart faces, in a pressure fixture that applies to and/or resists pressure from the DUT during testing, the pressure fixtures including a pair of spaced-apart pressure plates, the testing plate comprising:
a body designed and configured to be located between the DUT and one of the pressure plates when the DUT is pressurized within the pressure fixture, the body including:
a working face that confronts one of the spaced-apart faces of the battery cell during testing;
a plurality of recesses formed in the working face and distributed across the working face; and
a temperature sensor located in each one of the plurality of recesses; and
electronic circuitry in operative communication with each of the temperature sensors.

2. The testing plate of claim 1, wherein each of the temperature sensors is a negative temperature coefficient thermistor.

3. The testing plate of claim 1, wherein each temperature sensor has a front face confronting the battery cell during testing, wherein the front face is recessed within recess containing the temperature sensor.

4. The testing plate of claim 3, wherein, during testing, a thermal gel is located between each temperature sensor and the spaced-apart face of the DUT proximate to the testing plate.

5. The testing plate of claim 1, wherein the plurality of recesses are arranged in an array on the working face of the testing plate.

6. The testing plate of claim 1, wherein the testing plate includes 30 or more of each of the recesses and temperature sensors.

7. The testing plate of claim 6, wherein the testing plate includes 100 or more of each of the recesses and temperature sensors.

8. The testing plate of claim 1, wherein the temperature sensors are functionally grouped into a plurality of groups, and the electronic circuitry includes circuitry for processing temperature-sensor signals from the temperature sensors on a group-by-group basis.

9. The testing plate of claim 8, wherein the circuitry for processing temperature-sensor signals includes a plurality of analog-to-digital (A/D) converters.

10. The testing plate of claim 9, wherein the body includes a flexible printed circuit (FPC), and the A/D converters are located onboard the FPC.

11. The testing plate of claim 10, wherein the body further includes a rigid faceplate secured to the FPC, wherein the recesses are formed in the rigid faceplate.

12. The testing plate of claim 11, wherein the rigid faceplate comprises a printed circuit board (PCB).

13. The testing plate of claim 12, wherein the PCB includes the recesses and electrical contacts in bottoms of the recesses that electrically contact the thermal sensors.

14. The testing plate of claim 1, wherein the testing plate comprises a rigid faceplate containing a plurality of through-holes that provide the plurality of recesses.

15. The testing plate of claim 14, wherein the testing plate further comprises a backplane to which the temperature sensors are secured.

16. The testing plate of claim 15, wherein the backplane comprises a flexible printed circuit (FPC) containing electrical contacts in electrical communication with the plurality of sensors.

17. The testing plate of claim 1, wherein the body includes a pair of spaced-apart working faces, each having the plurality of recesses formed therein and distributed across the working face.

18. The testing plate of claim 17, wherein the body includes a backplane and a pair of rigid faceplates sandwiching the backplane and defining the plurality of recesses.

19. The testing plate of claim 18, wherein the backplane comprises a flexible printed circuit (FPC) containing electrical contacts in electrical communication with the plurality of sensors.

20. The testing plate of claim 16, wherein the FPC includes an external-contact region containing a plurality of external electrical contacts in electrical communication with corresponding respective ones of the electrical contacts that are in electrical contact with the plurality of sensors.

21. The testing plate of claim 20, wherein the FPC includes a lead-out region located between each working face present and the external-contact region, the lead-out region containing electrical conductors operatively connecting the plurality of external electrical contacts with the electrical contacts that are in electrical contact with the plurality of sensors.

22. An apparatus for testing a device-under-test (DUT) having spaced-apart faces, the apparatus comprising:
a pressure fixture that includes a pair of pressure plates and a pressurizing mechanism that causes the pressure plates to induce pressure within the DUT when the DUT is present between the pressure plates for testing, the spaced-apart faces facing corresponding ones of the pressure plates during the testing;
a testing plate in accordance with claim 1.

23. The apparatus of claim 22, wherein the DUT comprises a battery cell.

24. The apparatus of claim 22, wherein, during testing, a thermal gel is located between each temperature sensor and the spaced-apart face of the DUT proximate to the testing plate.

25. The apparatus of claim 22, wherein the temperature sensors are functionally grouped into a plurality of groups, and the electronic circuitry includes circuitry for processing temperature-sensor signals from the temperature sensors on a group-by-group basis.
